(19) United States
(12) Patent Application Publication
(10) Pub. No.: US 2002/0015357 A1
(43) Pub. Date: Feb. 7, 2002

(54) Splatter shield

(76) Inventors: Roland Langevin JR., Fall River, MA (US); William B. Baptista, Somerset, MA (US)

Correspondence Address: Richard C. Litman, LITMAN LAW OFFICES, LTD., P.O. Box 15035, Arlington, VA, 22215, US

(21) Appl. No.: 09/904,653

(22) Filed: Jul. 16, 2001

Related U.S. Application Data
(60) Provisional application No. 60/222,298, filed on Aug. 1, 2000.

(51) Int. Cl. B01F 15/00

(52) U.S. Cl. 366/347; 366/184; 366/349

(57) ABSTRACT

A shield, used during industrial material mixing operations for preventing material splatter around the mixing container. They shield is generally formed as a ring that snaps to the top of a conventional bucket. The ring includes an upwardly projecting funnel. The funnel captures materials that have been projected from the bucket during a mixing sequence. The shield is made of a form retaining, bendable or malleable material, such as plastic, or soft metals. This allows for the dried-on materials to be easily and quickly cleaned from the shield. Alternatively, the shield may include a plurality of weak seams provided in uniform intervals along its height for removing a portion of the shield for cleaning or reduction in size when required by a limiting work environment. A pull tab quickly and easily removes the funnel portion at the weak seam.

### CROSS-REFERENCE TO RELATED APPLICATION

This application claims the benefit of U.S. Provisional Patent Application Ser. No. 60/222,298, filed Aug. 1, 2000.

### BACKGROUND OF THE INVENTION

1. Field of the Invention

The present invention relates to a container snap on attachment and, more particularly, to a device for facilitating mixing of fluid materials within a container (particularly a bucket type container) and preventing portions of the materials from being projected or spilled out of the container during mixing.

2. Description of Related Art

It is well known that industrial craftsman such as painters, tile setters, masons, etc. typically use fluid materials that have to be mixed, stirred, or agitated in some manner before use. Often times the selected vessel for holding such fluid materials is a conventional cylindrically shaped bucket. These types of buckets are commercially available in a multiplicity of volume sizes, typically however, the two most generically found sizes are referred to as five gallon and three gallon buckets. These cylindrically shaped buckets have a generally standard open top having a diameter in the range of 9-12 inches.

Several devices in the prior art have evolved, specifically in accessories for paint cans, in aiding a painter to maintain a “waste free” work area. These devices are generally for scraping excess paint from a brush and/or preventing paint from clogging or fouling the paint can's rim or seal groove. Such examples of these prior art devices are as follows.

U.S. Des. Pat. No. 353,243 issued Dec. 6, 1994 to Millard, shows a paint brush holder and scraper for a paint can. U.S. Pat. No. Des. 366,615 issued Jan. 30, 1996 to Gearin, shows a mixing shield for a paint can. U.S. Pat. No. 332,043 issued Dec. 8, 1885 to Brien, discloses a paint can having a flared top and a drip ring. U.S. Pat. No. 2,151,895 issued Mar. 28, 1939 to Carlson, discloses a paint can attachment for preventing “slop” overruns of paint over the can rim.

U.S. Pat. No. 2,180,581 issued Nov. 21, 1939 to Eisenberg, discloses a paint can attachment for resting and scraping paint brushes thereon. U.S. Pat. No. 2,268,241 issued Dec. 30, 1941 to Brueckel, discloses a paint can top groove cover for preventing paint “slop” from entering the groove, and for directing the paint scraped from the brush back into the can. U.S. Pat. No. 2,591,482 issued Apr. 1, 1952 to Weltlich, discloses a paint can splash protector, similar to the Brueckel patent above, that prevents paint “slop” from entering the groove of a paint can top.

U.S. Pat. No. 2,668,635 issued Feb. 9, 1954 to Bennett, discloses a paint can shield for preventing undesirable paint “slop” on and around a paint can during a painting operation. The shield provides a flared or funnel ring which engages the top of a paint can, preventing the aforementioned paint “slop”. U.S. Pat. No. 3,326,409 issued Jun. 20, 1967 to Speer, discloses a paint can insert for preventing paint from dripping on and around the paint can. The insert, similar to the Bennett patent above, has a funnel or inverted cone shape that attaches to the top of a paint can.

U.S. Pat. No. 3,693,829 issued Sep. 26, 1972 to Price, discloses a protective apron for paint cans, the apron covers the groove in the top wall of a paint can, and extends inwardly into the can for scraping a brush and outwardly forming a moat for catching any paint “slop” from the can. U.S. Pat. No. 3,980,213 issued Sep. 14, 1976 to Ramsay, discloses a replacement cover for a paint can which allows the can to be easily resealed and provides access to the paint contained in the can via a portal in the replacement cover.

U.S. Pat. No. 3,998,352 issued Dec. 21, 1976 to Hopkins, discloses a rim shield for paint cans which also provides a means for scraping excess paint from a paint brush. U.S. Pat. No. 4,125,210 issued Nov. 14, 1978 to Embree, discloses a rim groove cover which allows a temporary resting place for a paint brush when not in use. U.S. Pat. No. 4,203,537 issued May 20, 1980 to McAlister, discloses a paint can accessory which mounts about the rim of a conventional paint can for scraping a paint brush, resting a paint brush, and preventing paint “slop” in the groove of the can top wall.

U.S. Pat. No. 4,969,617 issued Nov. 13, 1990 to Desjardins, discloses a semicircular attachment accessory for paint cans which securely covers a portion of the top wall groove of a paint can in order to prevent paint “slop” and to provide a brush scraper. U.S. Pat. No. 5,568,879 issued Oct. 29, 1996 to Kovathana, discloses a paint can attachment which is snap-fitted to the top of a paint can having the shape of an annular ring including a conical inner wall.

U.S. Pat. No. 5,752,619 issued May 19, 1998 to Fulton, discloses a paint can attachment designed to fit onto the top of a conventional paint can in order to provide a seal to prevent paint from dripping onto the rim of the can. British Pat. Document No. 2,163,123 published Feb. 19, 1986, discloses a paint brush scraping bar that is secured across the opened top of a paint can. British Pat. Document No. 2,213,459 published Aug. 16, 1989, discloses a paint brush scraper device which fits on the opened top of a paint can and the device includes a U-shaped member for supporting a brush across the top of the device.

None of the above inventions and patents, taken either singly or in combination, is seen to describe the instant invention as claimed.

### SUMMARY OF THE INVENTION

Accordingly, it is a principal object of the invention to provide a shield to prevent fluid material from splattering during mixing.

It is another object of the invention to provide a shield to prevent fluid material mixing splatter, the shield having a height that is reducible.

It is a further object of the invention to provide a shield to prevent fluid material mixing splatter that is adapted to securely attach to a container.

Still another object of the invention is to provide a shield to prevent fluid material mixing splatter having frangible seams that reduce the height of the shield.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a splatter shield according to the present invention.

FIG. 2 is a top perspective view of the splatter shield of the present invention.

FIG. 3 is a bottom perspective view of the splatter shield of the present invention.

FIG. 4 is a cross sectional view of the splatter shield along lines 4-4 of FIG. 2.

FIG. 5 is a top perspective view of an alternative embodiment of a splatter shield according to the present invention.

FIG. 6 is a cross sectional view of the splatter shield along lines 6-6 of FIG. 5.

Similar reference characters denote corresponding features consistently throughout the attached drawings.

### DETAILED DESCRIPTION OF THE PREFERRED EMBODIMENTS

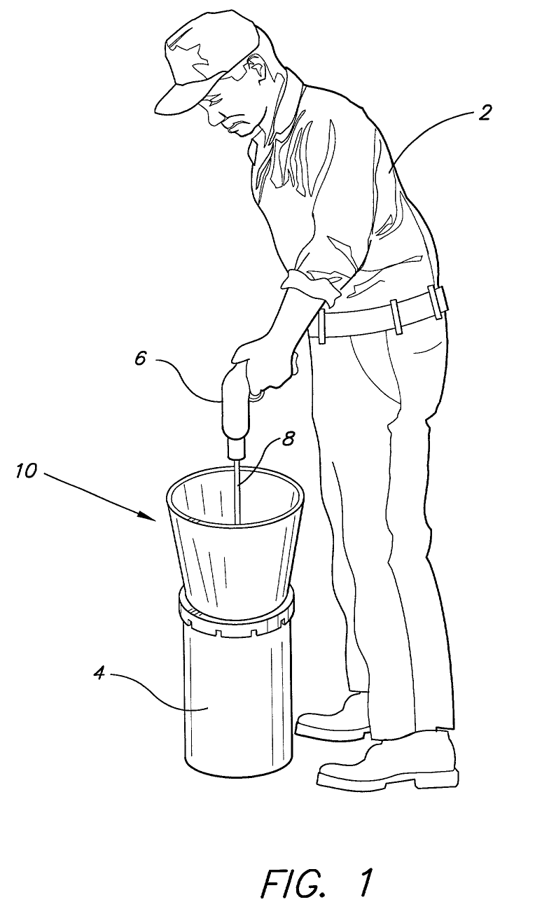

The present invention is a shield for preventing splatter of material from a mixing bucket. As seen in FIG. 1, an industrial craftsman 2 mixes fluid materials in a container 4 with a rotary power tool 6. The container 4 is a conventional and commercially available bucket, typically a standard plastic cylindrical bucket of the five or three gallon variety. The rotary power tool 6 turns an attachment shaft 8 having a stirring element (not shown) at the end thereof. When the rotary power tool 6 is actuated, a sloshing of the fluid materials occurs within the container 4. The sloshing results from the standard principles of physics (e.g., inertia) and ultimately causes portions of the fluid mixture to be projected from the container 4.

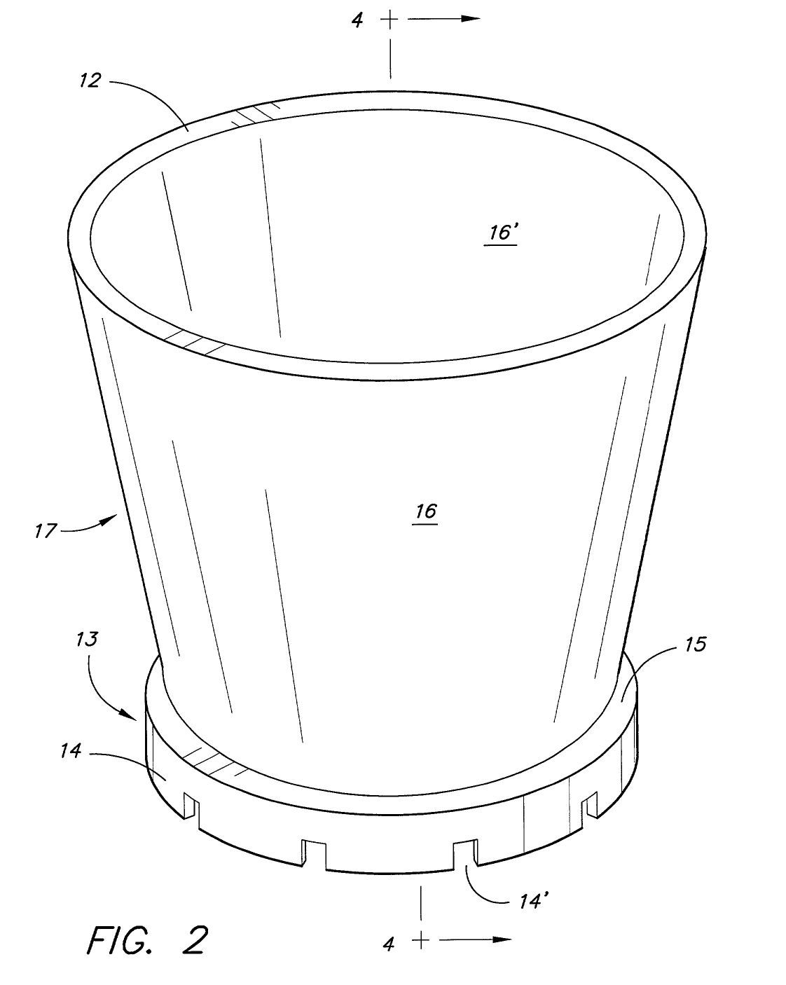

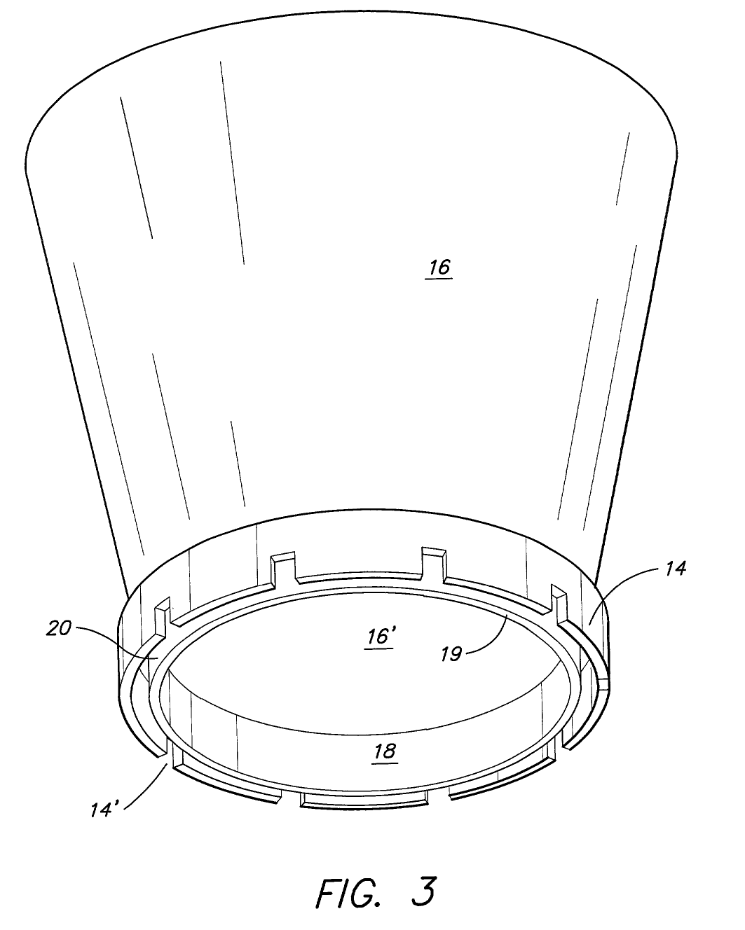

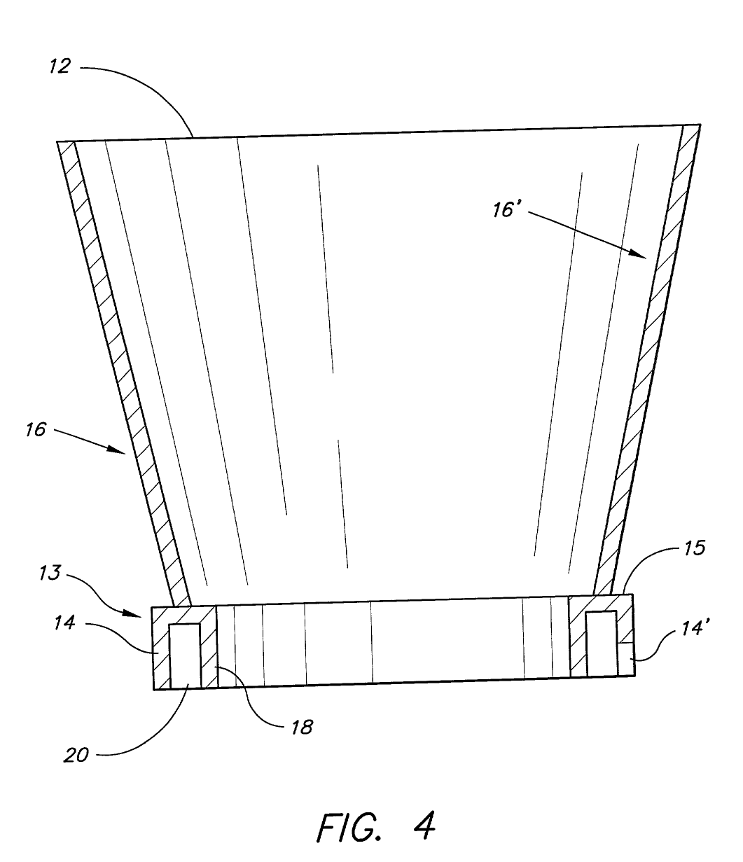

The shield of the present invention, designated generally as 10 in the drawings, prevents the projected fluid mixing materials from being expelled beyond the perimeter of the container 4. Referring to FIGS. 2-4, the first embodiment of the shield 10, according to the present invention, is illustrated. Shield 10 includes a ring 13 having a generally inverted U-shaped cross section. The inverted U-shaped cross section of the ring 13, seen most clearly in FIG. 4, has an inner leg or ring 18 and an outer leg or ring 14 joined by a top wall 15. The inner leg 18 has a solid peripheral edge. The outer leg 14 has a peripheral edge which includes a plurality of indentations or slots 14′. The slots 14′ are uniformly disposed about the perimeter of the outer leg 14 of the ring 13. The slots 14′ allow the outer ring 14 to expand for securing the shield 10 to the rim of a bucket, but the outer ring 14 is sufficiently resilient to return to its original shape after removal from the bucket. The shield 10 may be frictionally retained on the bucket between the inner ring 18 and the outer ring 14. The inner leg 18, said outer leg 14, and said top 15 define a channel 20 therein. The channel 20 has a diameter that is substantially equal to an open top diameter of the container 4. This allows the ring 13 to securely fit the top rim of a container 4 within the channel 20, and to be easily removed therefrom.

Opposite the channel 20, an inverted frusto-conical or funnel shaped member 17 extends upwardly from the inverted U-shaped ring 13. The member 17 has an outer surface 16, an inner surface 16′, a top edge 12, and a bottom edge 19 integral with and extending from the top 15 of inverted U-shaped ring. The funnel member has a predetermined height.

In addition, the top edge 12 defines an upper diameter and the bottom edge 19, likewise, defines a lower diameter. As clearly seen in FIGS. 2-4, the lower diameter of the funnel member 17 is less than the upper diameter of the funnel member 17. Further, the lower diameter of the funnel 17 is at most equal to the diameter of the channel 20. It is noted that the lower diameter of the funnel member 17 may be even less than the diameter defined by the inner leg 18. Preferably, the upper diameter defined by the top edge 12 is in the range from 10-14 inches. The channel 20 preferably has a diameter in the range of 9-12 inches, which typically corresponds to the conventional diameter of the container 4. The diameter of bottom edge 19 of the funnel member 13 is preferably in a range from less than 9 inches to no greater than 12 inches. However, the above dimensions represent preferred dimensions, and are not intended to limit the scope of the claimed invention. It is within the scope of this invention to expand and decrease these measurements.

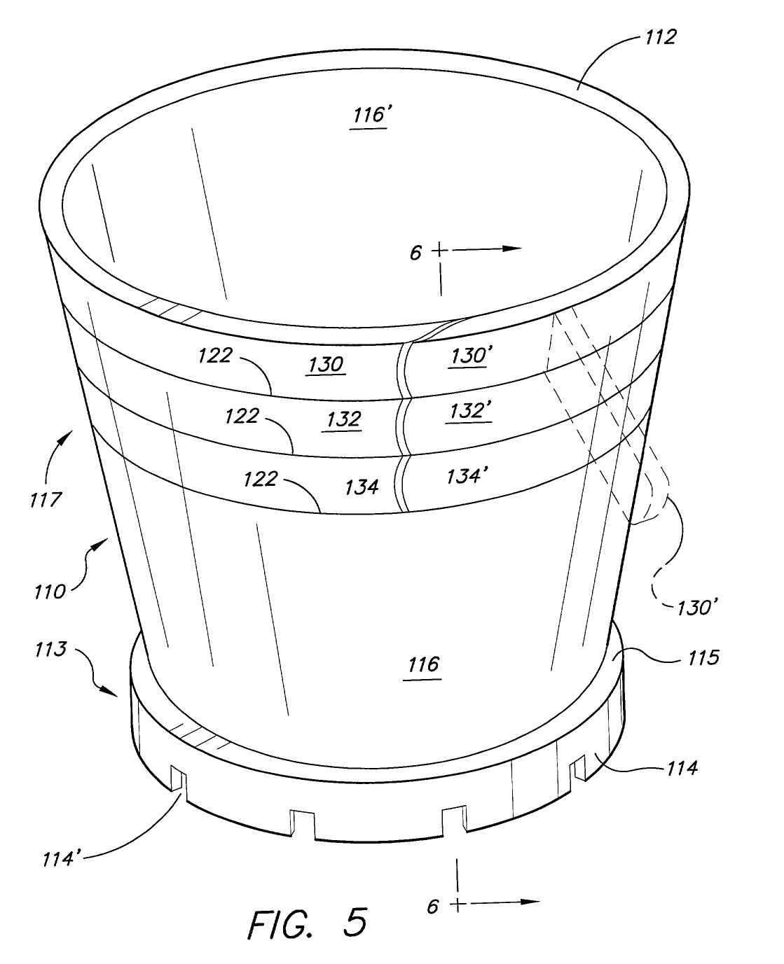

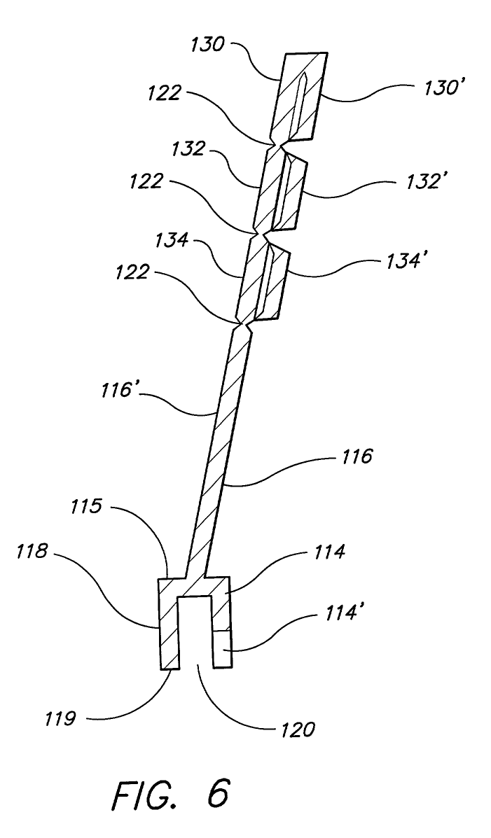

Referring to FIGS. 5 and 6, an alternative embodiment of the present invention is shown. The shield 110 according to FIGS. 5-6 has a similar construction to the shield 10 set forth in FIGS. 2-4, but further includes a funnel 117 with reducible height. Shield 110 has a ring 113 having a generally inverted U-shaped cross section. The inverted U-shaped cross section of the ring 113 includes a top 115, an inner leg 118 and an outer leg 114. The inner leg 118 has a solid peripheral edge. The outer leg 114 has a peripheral edge which includes a plurality of indentations or slots 114′. The slots 114′ are uniformly disposed about the perimeter of the outer leg 114 of the ring. The slots 114′ allow the outer ring 114 to expand and return to the original shape for attachment to a bucket. The inner leg 118, said outer leg 114, and said top 115 define a channel 120 therein. The channel 120 has a diameter that is substantially equal to an open top diameter of the container 4. This allows the ring 113 to securely fit the top rim of a container 4(see FIG. 1) within the channel 120, and to be easily removed therefrom.

Opposite the channel 120, an inverted frusto-conical or funnel shaped member 117 extends upwardly from the inverted U-shaped ring 113. The member 117 has an outer surface 116, an inner surface 116′, a top edge 112, and a bottom edge integral with and extending from the top 115 of inverted U-shaped ring. The funnel member 117 has a predetermined height.

In addition, the top edge defines a upper diameter and the bottom edge, likewise, defines a lower diameter. As clearly seen in these FIGS. 5-6, the lower diameter of the funnel member 117 is less than the upper diameter of the funnel member 117. Further, the lower diameter of the funnel 117 is at most equal to the diameter of the channel 120. It is noted that the lower diameter of the funnel member 117 may be even less than the diameter defined by the inner leg 118.

The funnel member 117 of shield 110 includes a plurality of weak seams 122. Each of the weak seams 122 are disposed at a height less than the height of the funnel member. The weak seams 122 partition the funnel member into mini-walls 130, 132, 134. The weak seams 122 are formed as indentations into both the outer surface 116 and the inner surface 116′ of the funnel member. Weak seams 122 are very frangible, so as to break on demand. Each mini-wall 130, 132, 134 includes a respective pull tab 130′, 132′, 134′. Each pull tab 130′, 132′, 134′ is integrally formed in the as an overlapping of the inner surface 116′ over the outer surface 116 in the funnel member. The pull tabs 130′, 132′, 134′ are releasably secured to the respective mini-wall 130, 132, 134 by at least one weak seam (not shown) that is similarly formed as weak seams 122. As shown in FIG. 5, one weak seam 122 is selectively broken by pulling pull tab 130′ (in phantom). This provides a vehicle for cleaning the funnel member 117 between uses. In addition, by breaking the weak seam 122 by pulling pull tab 130′ (in phantom) the height of the funnel member 117 is reduced when the industrial craftsman 2 (see FIG. 1) has to be in a confining space. For example, if industrial craftsman 2 is working in a crawl space, the total height of the funnel member on top of the container 4 may be too great, by merely breaking one or more of the weak seams 122, the funnel member and container 4 may be easily placed within the confining space.

Overall, the preferred height of shield 10 and 110 is in the range of 8-16 inches in both embodiments. However, in the second embodiment of FIGS. 5 and 6, each of the mini-walls 130, 132, 134 reduce the overall height of the shield 110 in uniform increments. For example, each mini-wall 130, 132, 134 is in, but no limited to, the range from 0.25 inch to 5.0 inches. In addition, the number of weak seams 122 provided in the funnel member 117 of the shield 110 is dependent upon and a function of the total height of the shield 110.

The shield 10 and 110 is made of a form retaining, bendable or malleable material, such as plastic, or soft metals. Preferably, the material is an easily recycled material, thus rendering the shield 10 and 110 environmentally friendly. For example, when constructed out of plastic, the preferred group is high density polyethylene (HDPE) 2, although any recyclable group is useable.

It is to be understood that the present invention is not limited to the sole embodiments described above, but encompasses any and all embodiments within the scope of the following claims.

We claim:

1. A shield for preventing splatter of material from a mixing bucket comprising:
a ring having a generally inverted U-shaped cross section, said inverted U-shaped cross section including a top, an inner leg and an outer leg, said inner leg having a solid peripheral edge, said outer leg having a peripheral edge including a plurality of uniformly spaced downward opening slots;
said inner leg, said outer leg, and said top defining a channel therebetween, said channel having a diameter, wherein said channel diameter is adapted to be substantially equal to an open top diameter of a desired bucket; and
a funnel integral with and extending from said top of said ring, said funnel having a predetermined height, an upper diameter and a lower diameter;
wherein said lower diameter of said funnel is less than said upper diameter of said funnel and said lower diameter of said funnel being at most equal to said diameter of said channel.

2. The shield according to claim 1, further comprising means for reducing the height of said funnel.

3. The shield according to claim 1, said funnel including at least one weak seam disposed at a height less than said predetermined height, said at least one seam being frangible, whereby the predetermined height is decreased when said at least one weak seam is broken.

4. The shield according to claim 3, further comprising means for selectively breaking said at least one weak seam, thereby reducing said predetermined height of said funnel.

5. The shield according to claim 4, wherein said means for selectively breaking said at least one weak seam includes a pull tab.

6. The shield of claim 1, wherein said desired bucket is a standard cylindrical, commercially available, plastic bucket.

7. The shield of claim 1, wherein said funnel upper diameter is in the range of from 10 inches to 14 inches.

8. The shield of claim 1, wherein said channel diameter is in the range of from 9 inches to 12 inches.

9. The shield of claim 1, wherein said funnel lower diameter is in the range of 9 inches to 12 inches.

10. The shield of claim 1, wherein said shield has a height within the range of 3 inches to 16 inches.

11. The shield of claim 3, wherein there are a plurality of weak seams forming mini-walls therebetween.

12. The shield of claim 3, wherein each of said mini-walls are in the range of 0.25 inches to 5 inches in height.

13. The shield of claim 1, wherein said shield is constructed of a form retaining, bendable material, such as plastic.

14. The shield of claim 1, wherein said plastic is high density polyethylene.

15. The shield of claim 1 wherein said shield is constructed of a form retaining malleable material, such as a soft metal.
